(19) United States
(12) Patent Application Publication
(10) Pub. No.: US 2006/0087548 A1
(43) Pub. Date: Apr. 27, 2006

(54) Image forming apparatus and an image forming method using the same

(75) Inventor: Joo-hwan Noh, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/246,123

(22) Filed: Oct. 11, 2005

(30) Foreign Application Priority Data
Oct. 21, 2004 (KR) 2004-84310

(51) Int. Cl. B41J 2/385

(52) U.S. Cl. 347/111

(57) ABSTRACT

An image forming apparatus comprises a pickup roller for picking up paper from a paper supply part and supplying the paper directly to a transfer nip (that is, the contact formed between a photoconductive drum and a transferring roller), a laser scanning unit for scanning a certain light onto the photoconductive drum, a paper sensor for detecting the top end of the paper being picked up and supplied by the pickup roller, a paper entry sensor for detecting the entry of the paper into the transfer nip, and a controller for updating a scanning point of the laser scanning unit based on the time from the detection of the top end of the paper by the paper sensor to the time the paper entry sensor detects entry of the top end of the paper into the transfer nip. Using this apparatus, an actual time for transferring the paper from the point of detecting the top end of the paper to the point of entrance of the paper into the transfer nip, is calculated, a shift amount with respect to a top margin stored to a controller is calculated based on the calculated information, the top margin value is updated by compensating the shift amount, and upon the error compensation, a light is scanned onto a following sheet of the paper by applying the updated top margin value, thereby processing an image. Accordingly, the top margin can be constantly maintained.

### CROSS-REFERENCE TO RELATED APPLICATIONS

This application claims the benefit under 35 U.S.C. § 119(a) of Korean Patent Application No. 2004-84310, filed Oct. 21, 2004, the entire disclosure of which is hereby incorporated by reference.

### BACKGROUND OF THE INVENTION

1. Field of the invention

The present invention relates to an image forming apparatus. More particularly, the present invention relates to an image forming apparatus that maintains a constant top margin on a sheet of paper by adjusting the scanning point of a laser scanning unit to compensate for variable paper transfer speeds, and a method for the same.

2. Description of the Related Art

In general, an electrophotographic image forming apparatus such as a laser printer produces an electrostatic latent image on a photoconductive medium, for example, a photoconductive belt, develops the electrostatic latent image using developers of certain colors, and transfers the developed image onto paper, thereby producing a desired image.

Japanese Patent Publication No. 2001-287399, filed on Oct. 16, 2001, and entitled “Printer,” discloses an image forming apparatus that maintains and controls the top margin (that is, the margin from the top end of the paper) while forming an image on paper. In the disclosed printer, when a print position adjusting mode is set, a central processing unit (CPU) operates the printer to print an L-shaped image. A discharge sensor in the discharge process detects the timing of the discharge of the top end of a paper while a reflection sensor detects the timing of the discharge of the L-shape image. The printer calculates a shift amount relative to a default top margin based on these detected timings. The printing start time (in a sub-scanning direction) is updated to compensate for the shift amount.

FIG. 1 is a schematic view of a conventional electrophotographic image forming apparatus 1 showing a printing process. Referring to FIG. 1, a surface of a photoconductive drum 3 is evenly charged by the electrical discharges of an electrifying roller 2. After charging, the photoconductive drum 3 is irradiated by a laser beam from a laser scanning unit 5 in a predetermined pattern. Therefore, a desired electrostatic latent image is formed on the surface of the photoconductive medium 3. The latent image is rotated into contact with a developing roller 7 and the electrostatic latent image is developed into a visible image by a toner.

Paper stacked on a paper supplying part 9 is transferred toward a feeding roller 13 by a pickup roller 11 and then toward a transferring roller 15 by the feeding roller 13. The toner image formed on the photoconductive drum 3 is transferred onto the paper by the pressure of the transferring roller 15. The transferred toner image is fixed by the heat and pressure of a fusing roller 17. The paper is transferred toward a paper discharging tray 21 by a discharging roller 18, thereby producing a desired printed work.

The image forming apparatus 1 described above may be further equipped with a paper sensor 25 near the output of the feeding roller 13. The paper sensor 25 detects the top end of the paper, and a control part (not shown) begins counting from the point of detecting the top end of the paper. The command processes to output a predetermined light through the laser scanning unit 5 begins a predetermined time after the detection of the top end of the paper.

To calculate the scanning time, the laser scanning unit 5 first calculates a time ΔT₁ from when the top end of the paper is detected by the paper sensor 25 to when the top end of the paper advances to the nip formed between the photoconductive drum 3 and the transferring roller 15. For convenience, the nip between the photoconductive drum 3 and the transferring roller 15 will be referred to as the “transfer nip.” A time ΔT₂ for maintaining the top margin is added to the time ΔT₁, thereby obtaining the time point of scanning ΔT₃ (for convenience, ΔT₃ will be referred to as the “top margin value.”)

The time ΔT₁ can be obtained based on an equation S=VT, wherein S denotes a traveled distance, V denotes a velocity, and T denotes a time. In other words, the time ΔT₁ can be calculated simply by using the distance L from the detecting point P₂ of the paper sensor 25 to the transfer nip P₁ for the traveled distance S and using a paper transfer speed for the velocity V. Since the distance L and the paper transfer speed are usually set as defaults during manufacture of the apparatus, the time ΔT₁ is easily obtained.

In a conventional image forming apparatus, the light is irradiated from the laser scanning unit 5 after the predetermined time ΔT₃ elapses after the top end of the paper is detected. The time ΔT₃ is based on the premise that the paper moves at a constant speed. In actuality, however, the paper transfer speed varies.

The paper transfer speed is variable due to numerous factors. For example, variations in the paper, in the component parts, and in the resistance of the paper moving path all affect the paper transfer speed. Variations in the paper include variations in thickness, quality, and surface conditions of the paper. Variations in the component parts include variations in the outer diameter of the feeding roller 13 and the friction coefficient of the feeding roller 13. Variations in other component parts, such as the pickup roller 11, can also affect the paper transfer speed. The resistance of the paper moving path refers to friction resistance between the paper and the paper moving path, which varies according to the paper transferring operation.

Thus, the paper transfer speed may change due to numerous, diverse factors. That is, it is practically infeasible to maintain a constant paper transfer speed. As a result, the top margin also varies.

Accordingly, there is a need for an image forming apparatus with an improved method and apparatus for maintaining a constant top margin on paper.

### SUMMARY OF THE INVENTION

An aspect of the present invention is to solve at least the above problems and/or disadvantages and to provide at least the advantages described below. Accordingly, an aspect of the present invention is to provide an image forming apparatus capable of maintaining a regular top margin by measuring the time from detecting the top end of a paper picked up by a pickup roller to the time the paper enters into a transfer nip and compensating a scanning point of a laser scanning unit based on the measured data.

Another aspect of the present invention is to provide a method for maintaining the constant top margin using such an image forming apparatus.

According to an aspect of the present invention, an image forming apparatus comprises a pickup roller for picking up a paper from a paper supply part and supplying the paper directly to a transfer nip, a laser scanning unit for scanning light onto the photoconductive drum, a paper sensor for detecting the top end of the paper being picked up and supplied by the pickup roller, a paper entry sensor for detecting the entrance of the paper into the transfer nip, and a controller for updating a scanning point of the laser scanning unit based on the time from the paper sensor detecting the top end of the paper being picked up to the time the paper entry sensor detects the entry of the paper into the transfer nip.

In a further aspect of the invention, the paper entry sensor comprises a resistance measuring device for measuring the resistance of the transfer nip.

In yet another aspect of the invention, a feeding roller can be provided between the pickup roller and the transfer nip while the paper sensor is disposed downstream of the feeding roller.

Another aspect of the present invention is to provide an image forming method comprising the steps of calculating an actual time for transferring paper (that is, the time from detecting the top end of the paper to the time the paper enters into the transfer nip); calculating a shift amount with respect to a stored top margin value based on the calculation of the actual time for transferring paper; updating the top margin value to compensate for the shift amount; and after compensating for the shift amount, scanning a light onto a sheet of paper by applying the updated top margin value, thereby processing an image.

In another aspect of the invention, the above steps are repeated as a cycle every time a sheet of images is processed.

In yet another aspect of the invention, a default top margin value is determined during manufacturing and stored to the controller. The top margin value is updated every time the cycle is repeated.

In a further aspect of the invention, during the step of calculating the paper transfer time, the point of detecting the entry of the paper into the transfer nip is determined by measuring changes in resistance at the transfer nip.

In another aspect of the invention, the change in resistance at the transfer nip is measured by detecting a variation between the resistance when paper is not yet at the transfer nip and the resistance when paper is passing through the transfer nip.

### BRIEF DESCRIPTION OF THE DRAWING FIGURES

The above and other objects, features, and advantages of certain embodiments of the present invention will be more apparent from the following description taken in conjunction with the accompanying drawings, in which:

FIG. 1 is a schematic view illustrating the printing processes of a conventional electrophotographic image forming apparatus;

FIG. 2 is a schematic sectional view of an image forming apparatus according to an embodiment of the present invention;

FIG. 3 is a schematic sectional view of an image forming apparatus according to another embodiment of the present invention;

FIG. 4 is a flowchart illustrating the process of compensating a top margin and processing an image using the structure of FIG. 2; and

FIG. 5 is a flowchart illustrating the process of compensating a top margin and processing an image using the structure of FIG. 3.

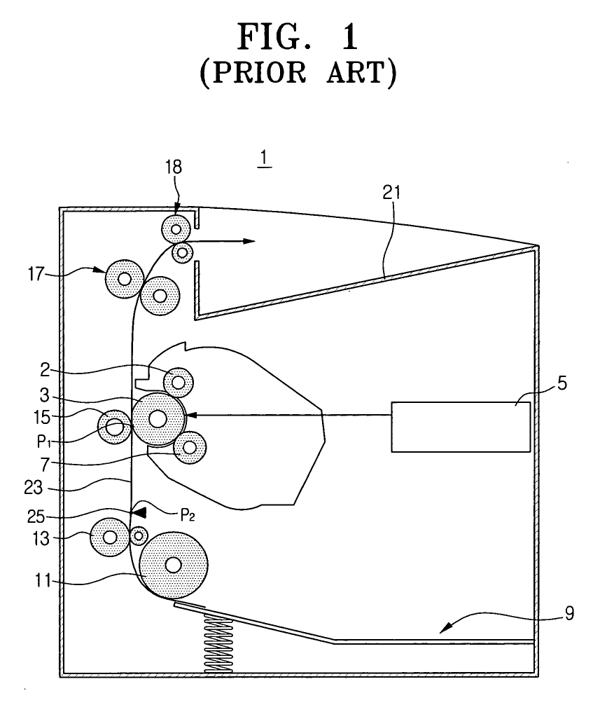

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

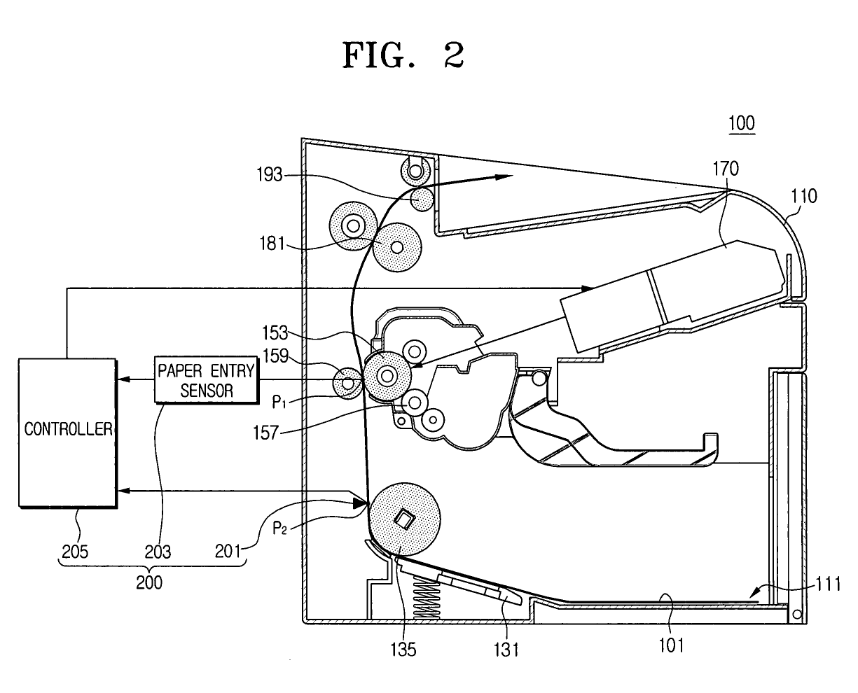

FIG. 2 is a sectional view schematically illustrating the entire structure of an image forming apparatus according to an embodiment of the present invention. Referring to FIG. 2, paper 101 stacked on a paper supply part 111 is picked up by a pickup roller 135 and transferred directly toward a transfer nip P₁ which is formed between a photoconductive drum 153 and a transferring roller 159. Simultaneously, a laser scanning unit 170 irradiates a predetermined light onto a surface of the photoconductive drum 153 to form an electrostatic latent image. The electrostatic latent image is developed with toner into a visible image by being rotated in contact with the developing roller 157. The paper is passed through the transfer nip P₁ and the toner image formed on the photoconductive drum 153 is transferred onto the paper 101 by the pressure of the transferring roller 159. The toner image transferred onto the paper 101 is fixed by the heat and pressure of a fusing roller 181. The paper 101 with the fixed image is discharged from a main body 110 of the image forming apparatus 100 by a discharging roller 193.

Additionally, the time required to transfer the paper 101 from a certain position after passing through the pickup roller 135 to the transfer nip P₁ is measured. The top margin, which is the distance from the top end of the paper 101 to a first-formed image, is compensated according to the measured paper transfer time. To accomplish this, a scanning point compensating unit 200 is provided to adjust the scanning point of the laser scanning unit 170.

The scanning point compensating unit 200 comprises a paper sensor 201 for detecting the top end of the paper 101 (which is fed by the pickup roller 135), a paper entry sensor 203 for detecting the entry of the paper 101 into the transfer nip P₁, and a controller 205 for compensating a scanning point of the laser scanning unit 170 by measuring the time from when the paper sensor 201 detects the top end of the paper 101 to the time when the paper entry sensor 203 detects entry of the paper 101 into the transfer nip P₁.

The paper entry sensor 203 may be a resistance measurer for measuring resistance at the transfer nip P₁. The paper entry sensor 203 detects the entry of paper 101 into the transfer nip P₁ by using the variation between the resistance when paper 101 has not yet passed through the transfer nip P₁ and the resistance when paper 101 is passing through the transfer nip P₁.

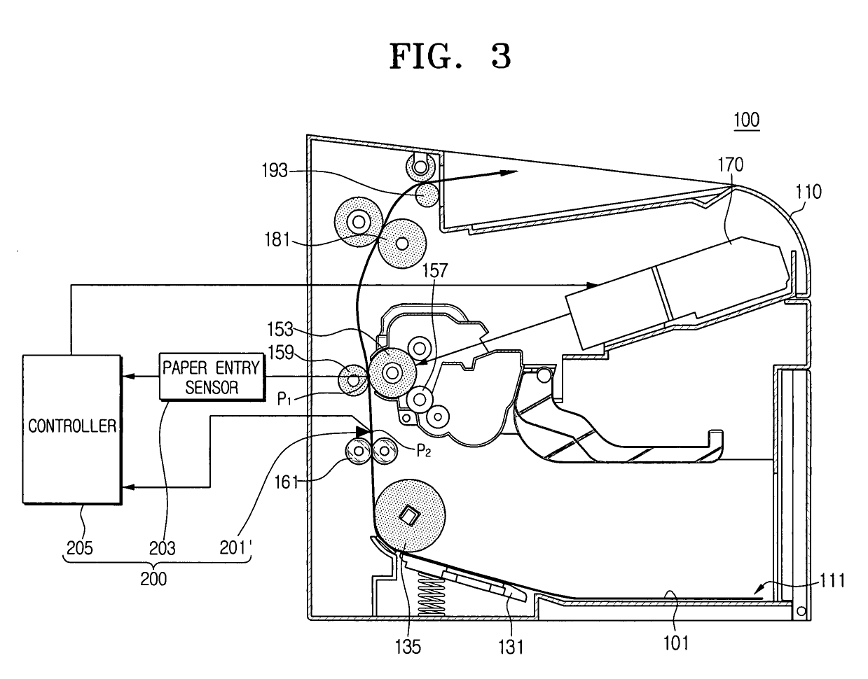

FIG. 3 shows the structure of an image forming apparatus according to another embodiment of the present invention. The structure of FIG. 3 is similar to that of FIG. 2. In this embodiment, however, the paper 101 picked up by the pickup roller 135 is not directly transferred to the transfer nip P₁. Instead, it is picked up by the pickup roller 135, transferred by a feeding roller 161, and then advanced into the transfer nip P₁. Also, in this embodiment, the paper sensor 201 is disposed downstream of the feeding roller 161. A description of the other, conventional elements will be omitted for clarity and conciseness.

The processes for compensating the scanning point of the laser scanning unit 170 according to the variable paper transfer speed will now be described in greater detail. Since the general operations for forming an image are already described with reference to FIG. 2, the focus of the following explanation will be the process for compensating and applying a top margin.

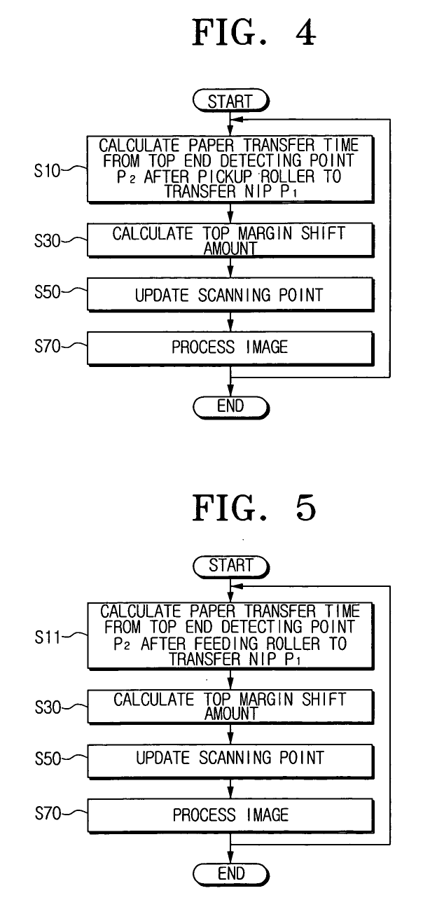

FIG. 4 is a flowchart illustrating the process of compensating a top margin according to the structure of FIG. 2 and thereby processing the image. Referring to FIG. 4, while a first sheet of the paper is processed, the paper sensor 201 detects the top end of the paper 101 downstream of the pickup roller 135. Also, the point in time that the paper 101 enters the transfer nip P₁ is detected by the paper entry sensor 203. The entry time is determined by measuring the change in resistance at the transfer nip P₁. More specifically, when the paper 101 is advanced to the transfer nip P₁, the resistance output from the transfer nip P₁ is considerably different than the resistance output when the paper 101 has not yet advanced to the transfer nip P₁. The point in time that the resistance changes is considered as the entry of the paper 101 (S10).

Based on the top end detecting time and the paper entry detecting time, the controller 205 calculates a shift amount relative to a stored top margin value (S30).

Information on the “default top margin ΔT_{d}” is primarily stored to the controller 205 through a storing medium. The “default top margin ΔT_{d}” is obtained by calculating a time ΔTᵣ from the top end detecting point P₂ of the paper sensor 201 to the transfer nip P₁ and adding the time ΔTₐ for keeping the top margin to the time ΔTᵣ (ΔT_{d}=ΔTᵣ+ΔTₐ). The time ΔTᵣ is obtained using the same processes used to calculate the time ΔT₁ in the prior art. Therefore, further details of the process are omitted for clarity and conciseness.

The top margin value is updated by compensating the shift amount (S50). The shift amount compensation is achieved by comparing the actual paper transfer time (which is measured based on the top end detecting point P₂ and the paper entry detecting point into the transfer nip P₁) with a reference value corresponding to a stored top margin value. If the measured value is greater than the reference value, the scanning point is advanced by a time corresponding to the difference between the measured value and the reference value. In contrast, if the measured value is less than the reference value, the scanning point is delayed by the difference between the values. Accordingly, the top margin is constant.

Next, applying the updated top margin, the light is scanned onto the next sheet of paper at the point in time corresponding to the shift amount compensation, thereby processing the image (S70).

The steps S10 through S70 are repeated as one cycle. The top margin value stored by the controller 201 is updated every repetition of the cycle. More specifically, when a first sheet of the paper is processed, a shifted amount is calculated relative to the “default top margin ΔT_{d},” thereby updating a “first top margin”. When processing the next sheet of the paper 101, a new shift amount is calculated based on the “first top margin,” thereby producing an updated “second top margin”. These processes are repeated for every sheet of paper. Of course, the “second top margin” could also be calculated relative to the “default top margin ΔT_{d}”.

FIG. 5 is a flowchart for illustrating an image forming process according to another embodiment of the present invention. Step 511 in the process of FIG. 5 differs from step S10 of FIG. 4. In step S11 of FIG. 5, the top end of the paper 101 is sensed downstream of the feeding roller 161 after the paper 101 is picked up by the pickup roller 135. The other processes are performed in the same manner as the processes in FIG. 4. Therefore, a description of those processes is omitted.

Using the above-described exemplary embodiments of the present invention, the paper transfer time from the top end detecting point to the paper entry detecting point is measured and the scanning point is compensated based on the measured data. As a result, the top margin is maintained at a regular value.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a pickup roller for picking up paper from a paper supply part and supplying the paper to a transfer nip formed between a photoconductive drum and a transferring roller;
a laser scanning unit for scanning light onto the photoconductive drum;
a paper sensor for detecting the top end of the paper being supplied by the pickup roller;
a paper entry sensor for detecting the entrance of the paper into the transfer nip; and
a controller for updating a scanning point of the laser scanning unit based on the time from the paper sensor detecting the top end of the paper being picked up to the time the paper entry sensor detects the entry of the paper into the transfer nip.

2. The image forming apparatus of claim 1, wherein the paper entry sensor comprises a resistance measuring device for measuring the resistance of the transfer nip.

3. An image forming apparatus comprising:
a pickup roller for picking up a paper from a paper supply part;
a feeding roller for supplying the paper to a transfer nip formed between a photoconductive drum and a transferring roller;
a laser scanning unit for scanning light onto the photoconductive drum;
a paper sensor for detecting the top end of the paper being supplied by the feeding roller;
a paper entry sensor for detecting the entrance of the paper into the transfer nip; and
a controller for updating a scanning point of the laser scanning unit based on the time from the paper sensor detecting the top end of the paper being picked up to the time the paper entry sensor detects the entry of the paper into the transfer nip.

4. The image forming apparatus of claim 3, wherein the paper entry sensor comprises a resistance measuring device for measuring the resistance of the transfer nip.

5. An image forming method comprising the steps of:
picking up a paper with a pickup roller and supplying the paper directly to a transfer nip formed between a photoconductive drum and a transferring roller;
calculating the actual time for transferring a paper from the point that the top end of the paper is detected to the point where the paper enters the transfer nip;
calculating a shift amount with respect to a stored top margin value based on information obtained by the step of calculating the actual time of paper transfer;
updating the top margin value by compensating the shift amount; and
scanning a light onto a following sheet of the paper by applying the updated top margin value, thereby processing an image.

6. The method of claim 5, wherein all the steps are repeated as a cycle every time a sheet of images is processed.

7. The method of claim 6, wherein a default top margin is determined during manufacturing and stored to the controller, and the top margin value is updated every time the cycle is repeated.

8. The method of claim 5, wherein, during the step of calculating the paper transfer time, the entry of the paper into the transfer nip is measured by detecting the variation in resistance between when the paper is not yet at the transfer nip and the resistance when paper is passing through the transfer nip.

9. An image forming method comprising the steps of:
picking up a paper with a pickup roller and supplying the paper to a transfer nip formed between a photoconductive drum and a transferring roller with a feeding roller;
calculating the actual time for transferring a paper from the point that the top end of the paper is detected to the point where the paper enters a transfer nip;
calculating a shift amount with respect to a stored top margin value based on information obtained by the step of calculating the actual time of paper transfer;
updating the top margin value by compensating the shift amount; and
scanning a light onto a following sheet of the paper by applying the updated top margin value, thereby processing an image.

10. The method of claim 9, wherein all the steps are repeated as a cycle every time a sheet of images is processed.

11. The method of claim 9, wherein a default of the top margin is determined during manufacturing and stored to the controller, and the top margin value is updated every time the cycle is repeated.

12. The method of claim 9, wherein, during the step of calculating the paper transfer time, the entry of the paper into the transfer nip is measured by detecting the variation in resistance between when the paper is not yet at the transfer nip and the resistance when paper is passing through the transfer nip.
